(19) United States
(12) Patent Application Publication
(10) Pub. No.: US 2004/0189786 A1
(43) Pub. Date: Sep. 30, 2004

(54) Laser array imaging lens and image-forming device

(76) Inventor: Hiromitsu Yamakawa, Saitama City (JP)

Correspondence Address: Arnold International, P.O. BOX 129, Great Falls, VA, 22066, US

(21) Appl. No.: 10/811,921

(22) Filed: Mar. 30, 2004

(30) Foreign Application Priority Data
Mar. 31, 2003 (JP) 2003-094200

(51) Int. Cl. B41J 2/435; G01D 15/14; B41J 2/45; B41J 15/14; B41J 27/00; G02B 13/08

(52) U.S. Cl. 347/224; 359/668

(57) ABSTRACT

A laser array imaging lens is disclosed that is formed of, in order from the light-source side: a first lens component with or without a stop positioned at a specified distance on the image plane side of the first lens component, and a second lens component. At least one surface of the laser array imaging lens is an aspheric surface. In addition, one or more anamorphic, aspheric surfaces may be provided and a diffractive optical element (DOE) that is defined by a phase function may be provided, either superimposed on the at least one aspheric surface or formed on another surface of the laser array imaging lens. Preferably, a specified Condition (3) is satisfied so as to reduce aberrations while maintaining the laser array imaging lens so as to be substantially telecentric on the light-source side.

### BACKGROUND OF THE INVENTION

A rotary polygon mirror has been generally used as the light-scanning means in image-forming devices such as laser printers. Although a rotary polygon mirror provides superior scanning in terms of both higher speed and better accuracy in capturing or reproducing the correct shading as compared to when a galvanometer mirror is used for scanning, the subtle bending of scanning lines, the variation of scanning line pitch, as well as the variation of scanning line length that result from manufacturing variations deteriorate the quality of scanning when a rotary polygon mirror is used. Moreover, in a scanning unit that uses such a rotary polygon mirror, a sensor for detecting the timing of the scans is needed for making the starting points coincide. Furthermore, vibrations and/or noise may be generated due to the rotational operation of a rotary polygon mirror.

Various problems as described above arise when a rotary polygon mirror is used to scan a light beam. Moreover, there is a limitation as to both the scanning speed and acceleration of a rotary polygon mirror. Thus, imaging techniques that are equivalent in result to scanning a laser light without using a rotary mirror have been investigated to further enhance the image-forming speed. When such techniques are used, beams from laser light sources need to be accurately guided onto a surface, and thus the development of an laser array imaging lens suited to this task is required.

Image-forming devices that use a so-called ‘semiconductor laser array’, made by arraying multiple light emitting elements in rows, as a light source and that use a laser array imaging lens that images light beams from such a light source onto a surface to be scanned are described Japanese Laid-Open Patent Applications H10-16297 and 2000-249915.

However, the laser array imaging lens described in Japanese Laid-Open Patent Application H10-16297 has a seven lens element construction that uses only spherical lenses. A laser array imaging lens of a lighter and simpler construction than this conventional example has been desired. Further, the laser array imaging lens described in Japanese Laid-Open Patent Application 2000-249915 is constructed of two anamorphic, aspheric lens elements and a stop. The anamorphic feature of the two surfaces functions to refract rays in the scanning versus the sub-scanning direction with different refractive power, thereby enabling the two anamorphic, aspheric lens elements to refract light rays that are situated at the center of the astigmatic (i.e, rotationally non-symmetric) light beams that are incident onto the laser array imaging lens so that they intersect at one point in a region on the optical axis that is located at the back focal plane of the first lens element of the laser array imaging lens, and a stop is placed at this position on the optical axis to thereby make the laser array imaging lens telecentric on the light-source side. In particular, a more favorable correction of the distortion has been desired.

### BRIEF SUMMARY OF THE INVENTION

The present invention relates to an image-forming device wherein a so-called semiconductor laser array, composed by arranging multiple light emitting elements in an array, is used as a light source, and the image-forming device directs light rays emitted from the light source onto an object surface to be scanned and forms a reproduction image on the surface to be scanned, and also relates to an laser array imaging lens used with the image-forming device.

### BRIEF DESCRIPTION OF THE DRAWINGS

The present invention will become more fully understood from the detailed description given below and the accompanying drawings, which are given by way of illustration only and thus are not limitative of the present invention, wherein:

FIGS. 1A and 1B are top and side views, respectively, of a laser printer according to a first embodiment of the present invention;

FIG. 2 shows a beam emergent from a laser element such as an LED (light emitting diode);

FIG. 3 is a side view of a laser printer according to the present invention that relates to a second embodiment;

FIG. 4 illustrates a semiconductor laser array light source formed of multiple laser elements arranged in rows;

FIG. 5 shows the lens element configuration of a laser array imaging lens according to the present invention that relates to Embodiments 1 through 7 thereof;

FIG. 6 shows the lens element configuration of a laser array imaging lens according to the present invention that relates to Embodiment 8 thereof;

FIGS. 7A-7D show various aberration diagrams of the laser array imaging lens relating to Embodiment 1;

FIGS. 8A-8D show various aberration diagrams of the laser array imaging lens relating to Embodiment 2;

FIGS. 9-9E show various aberration diagrams of the laser array imaging lens relating to Embodiment 3;

FIGS. 10A-10D show various aberration diagrams of the laser array imaging lens relating to Embodiment 4;

FIGS. 11A-11D show various aberration diagrams of the laser array imaging lens relating to Embodiment 5;

FIGS. 12A-12D show various aberration diagrams of the laser array imaging lens relating to Embodiment 6;

FIGS. 13A-13E show various aberration diagrams of the laser array imaging lens relating to Embodiment 7; and

FIGS. 14A-14D show various aberration diagrams of the laser array imaging lens relating to Embodiment 8.

### DETAILED DESCRIPTION

Definitions of the terms “lens element” and “lens component” that relate to this detailed description will now be given. The tern “lens element” is herein defined as a single transparent mass of refractive material having two opposed refracting surfaces, which surfaces are positioned at least generally transverse to the optical axis of the laser array imaging lens. The term “lens component” is herein defined as (a) a single lens element spaced so far from any adjacent lens element that the spacing cannot be neglected in computing the optical image forming properties of the lens elements or (b) two or more lens elements that have their adjacent lens surfaces either in full overall contact or so close together that the spacings between adjacent lens surfaces of the different lens elements are so small that the spacings can be neglected in computing the optical image forming properties of the two or more lens elements. Thus, some lens elements may also be lens components. Therefore, the terms “lens element” and “lens component” should not be taken as mutually exclusive terms. In fact, the terms may frequently be used to describe a single lens element in accordance with part (a) above of the definition of a “lens component.”

In accordance with the definitions of “lens component,” and “lens element” above, lens elements may also be lens components. Thus, the present invention may variously be described in terms of lens elements or in terms of lens components.

The present invention relates to a laser array imaging lens having a simple construction and that images light rays from a semiconductor laser array light source onto an object surface to be scanned without using a rotating polygon mirror, as well as to an image-forming device using this laser array imaging lens. More specifically, the laser array imaging lens forms an image of luminous fluxes from a semiconductor laser array light source that is formed by arranging multiple light emitting elements in one or more rows.

The laser array imaging lens of the present invention includes two lens components, without any intervening lens component, in order from the light-source side as follows: a first lens component which functions to refract light rays that are emitted at the center of each luminous flux from each of the above-mentioned light emitting elements so that they cross the optical axis and intersect at a common region; and a second lens component that is arranged to receive the light rays that have crossed the optical axis in the common region, with at least one lens surface among the lens surfaces of the first lens component and the second lens component being an aspheric surface.

It is preferable that at least one lens surface among the surfaces of the first lens component and the second lens component is formed with an anamorphic, aspheric surface. Further, it is preferable that at least one lens surface among the surfaces of the first lens component and the second lens component be formed with a diffraction optical element having a phase function, which may be superimposed or may be a separate surface.

Further, in the laser array imaging lens, it is preferable that a stop be arranged in the vicinity of the above-mentioned common region where light beams situated in the vicinity of the center of each luminous flux from each of the above-mentioned light emitting elements intersect.

Also, it is preferable that the laser array imaging lens be substantially telecentric on the light-source side.

The image-forming device of the present invention is characterized by the fact that it is equipped with the laser array imaging lens of the present invention and further includes: a semiconductor laser array light source that is formed by arranging multiple light emitting elements in one or more rows so as to emit light beams to the laser array imaging lens; a means that independently modulates any individual light emitting element in the above-mentioned semiconductor laser array light source based upon predetermined signal(s); and a means that relatively moves an object surface to be scanned that is arranged in the vicinity of the image surface of the above-mentioned laser array imaging lens in a sub-scanning direction that is roughly perpendicular to the row direction of the images of the one or more rows of multiple light emitting elements.

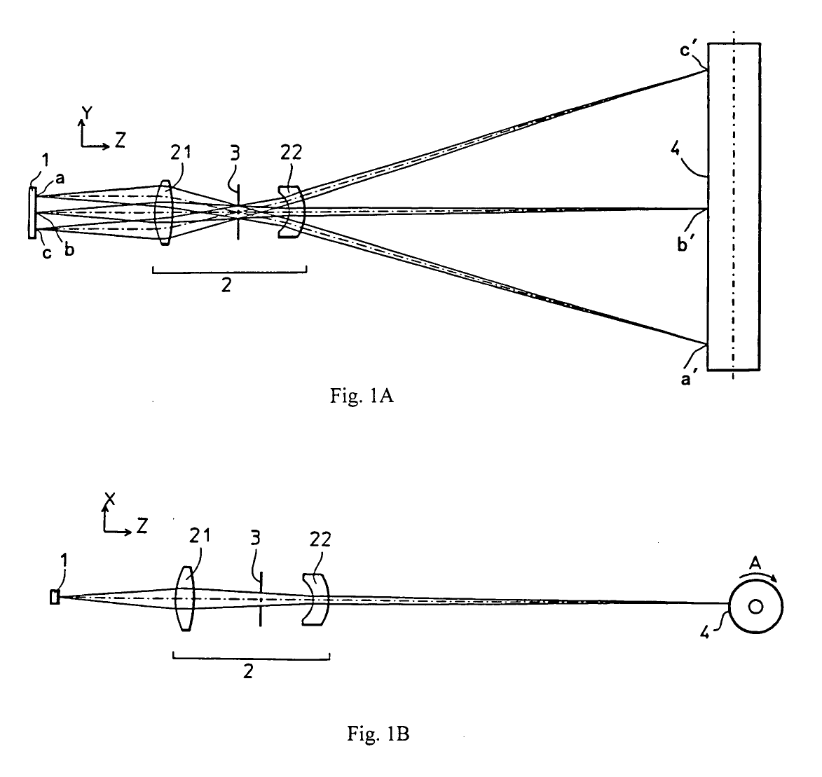

FIGS. 1A and 1B are schematic diagrams that show a laser printer using the laser array imaging lens of the present invention. This laser printer is equipped with a laser array light source 1 that is formed by arranging many semiconductor laser light emitting elements such as at the positions a, b, c in one or more rows, and a laser array imaging lens 2 that is formed of two lens components arranged along an optical axis in the Z direction which images the luminous fluxes from each of the light emitting elements onto an image surface 4 where a photosensitive surface is positioned that is to be scanned. FIG. 1A is a cross-sectional view, as viewed from above showing the Y-Z plane, that shows light emitting elements at points a, b, and c, for example, of the laser light source 1 arranged in a row, and shows the optical axis direction Z of a laser array imaging lens 2 that receives the light beams emitted by the laser array light source and images the light beams from these points as dots c′ b′ a′ onto a photosensitive surface that may be moved in sub-scanning direction. FIG. 1B is a cross-sectional view of the laser printer shown in FIG. 1A, but as viewed in the Y direction, with the arrow A indicating the movement of the image surface 4 in the sub-scanning direction.

A light source having over 2,000 laser elements is needed to illuminate a scan line with a length sufficient to scan A6 size paper at a pitch of 600 dots per inch. Since the short side of A6 (postcard size) paper has a length of 105 mm, if the A6 paper is oriented with its short side in the main scanning direction, the number of laser elements that should be arrayed is (600 dots per inch) times (105 mm/(25.4 mm per inch))=2,480 dots. However, printing is usually not needed for a range of several mm for each margin. Therefore, if over 2,000 laser elements are arrayed in a straight line, the printing of a scanning line at a pitch of 600 dots per inch onto A6 paper can be accomplished.

An image of the light emitting region from many laser elements that are linearly arranged as mentioned above is formed by the laser array imaging lens 2 at predetermined positions along a predetermined straight line at the image surface 4. A simultaneous one-time emission of light from each laser element of the light source 1 enables the formation of linear dot arrays (equivalent to one scanning line) onto a photosensitive surface that is positioned at the image surface 4 and which can be moved in a sub-scanning direction, as indicated by the arrow A in FIG. 1B. By emitting light from the light source 1 at a predetermined timing while moving the photosensitive surface at a predetermined speed in the direction A of the arrow, which is roughly perpendicular to the rows of dots at the image surface 4, a reproduction image can be recorded onto the photosensitive surface.

In the present embodiment, since a light beam which has been independently modulated is emitted from each of the laser elements, the equivalent of one scanning line is formed for each row of light emitting elements in the light source 1. Therefore, no rotating polygon mirror is used to form a scan line, thereby avoiding the problems and costs associated with such a mechanical device. In other words, since optical scanning is not performed by a mechanical scanning means, the various problems associated with such a scanning means, such as variations in the mirror surface orientation due to manufacturing tolerances and vibrations that cause inaccuracy in the scanning do not arise. Needless to say, a sensor for the purpose of obtaining the timing for the start of each scanning line, as required in the case of using the conventional rotating polygon mirror, is no longer required. Further, since there are no parts that move at high speed, vibration and noise are reduced to a low level and it is possible to secure an extended, usable life span. In addition, by simultaneously emitting light from each laser element, the printing of one or more lines simultaneously on the photosensitive surface to be scanned can be performed, enabling high-speed printing to be achieved.

The reason a semiconductor laser element is preferred as a light emitting element in the light source 1 is because the semiconductor laser is dramatically advantageous from the standpoint of the quantity of light and the ability to modulate the light output from the light emitting elements. As an alternate light emitting means, a total internal reflection system can instead be used, where luminous fluxes which have been divided are simultaneously modulated by a predetermined modulator using a gas laser, such as an He—Ne laser. However in this case, the optical system becomes extremely complicated, and it is necessary to divide the luminous flux from one laser tube, for example, into thousands of luminous fluxes so, for the purpose of securing a necessary quantity of light for high-speed optical scanning, a high-power laser tube will be required. Further, in this system, the size of the gas laser tube and the distance from the laser tube to the optical modulator also becomes longer, so it becomes difficult to realize a compact device. Also, the cost becomes relatively expensive.

The laser array imaging lens 2 is formed of, in order from the light-source side, a first lens component 21, which refracts the light rays situated in the vicinity of the center of each luminous flux from each laser element of the light source 1 so as to cause them to intersect the optical axis in a common region, and a second lens component 22 that is arranged so as to receive the light that has passed through the common region where these light rays intersect one another. Luminous fluxes transmitted from laser elements situated at points a, b, and c in the light source 1, are converged onto points a′, b′ and c′, respectively, at the image surface 4. In other words, due to the effect of the laser array imaging lens, the line of the points of each laser element in the light source 1 versus the line of the points on the image surface 4 are reversed in order, as shown in FIG. 1A. Using a laser array imaging lens having a two lens component construction, wherein the light rays that are situated in the vicinity of the center of each luminous flux from each laser element intersect between the first lens component 21 and the second lens component 22, enables the correction of aberrations to become easy as compared to using a laser array imaging lens having a single lens component construction. Thus, even in the case where an important design factor is that the overall length of the laser array imaging lens be compact and provide a wide angle of view, excellent image quality can be attained using a two-lens-component construction. Furthermore, it is preferable that the above-mentioned common region where the light rays intersect is substantially at a point on the optical axis of the laser array imaging lens 2.

Among the lens surfaces of the lens components 21 and 22 that form the laser array imaging lens of the present invention, at least one surface is an aspheric surface that is defined using the following Equation (A):

Z=ρ²/R/(1+(1−K·ρ²/R²)^{1/2})+ΣA₂ᵢρ²ⁱ Equation (A)

where

Z is the length (in mm) of a line drawn from a point on the aspheric lens surface at a distance ρ from the optical axis to the tangential plane of the aspheric surface vertex,

R is the radius of curvature of the aspheric lens surface on the optical axis,

ρ is the distance (in mm) from the optical axis,

K is the eccentricity, and

Aᵢ is the ith aspheric coefficient and the summation extends over i.

In embodiments of the invention disclosed below, only the aspheric coefficients A₄, A₆, A₈ and A₁₀ are non-zero.

Even though it is comparatively easy to manufacture a rotationally symmetric, aspheric surface, the effect of aberration improvement can be significant, and even with a simple, two-lens-component construction, excellent image quality can be achieved. Further, a laser array imaging lens 2 having a two-lens-component construction can be both low in cost and lightweight. In addition, as long as relative positional errors between the two lens components are reduced to a minimum, highly accurate assembly becomes unnecessary, so the device assembly becomes easy.

Further, in the laser array imaging lens 2 of the present invention, it is preferable that at least one lens surface of the two lens components 21 and 22 be formed with an anamorphic, aspheric surface. The anamorphic, aspheric surface has a different refractive power along the direction of the rows of the multiple laser elements versus a direction perpendicular thereto, and is defined using the following Equation (B):

Z′=(CR·X²+Y²/R′)/(1+(1−[(K_{AX}·(CR·X)²+K_{AY}·(Y/R′)²])^{1/2})+ΣA₂ᵢ[(1−Kᵢ)·X²+(1+Kᵢ)·Y²]ⁱ Equation (B)

where

Z′ is the length (in mm) of a line drawn from a point situated at position (X,Y) on the aspheric lens surface to the tangential plane at the aspheric lens surface vertex;

X is the X direction component of the distance of the point from the optical axis;

Y is the Y direction component of the distance of the point from the optical axis;

CR is the paraxial curvature in a plane containing the X and Z axes;

R′ is the paraxial radius of curvature in a plane containing the Y and Z axes;

K_{AX} is the eccentricity of the X direction;

K_{AY} is the eccentricity of the Y direction;

A₂ᵢ is a rotational symmetry component aspheric coefficient, where i=2-5; and,

Kᵢ is a non-rotational symmetry component aspheric coefficient, where i=2-5.

Forming the surface as an anamorphic, aspheric surface enables separate focusing in the row direction of the laser elements versus a direction perpendicular thereto. Thus, in the usual case where there is an astigmatism in the luminous fluxes emitted from each laser element along the above-mentioned two directions, it becomes easy to separately correct the luminous fluxes in each direction that are focused onto the image surface.

In addition, by using an anamorphic, aspheric surface for at least two of the lens component surfaces in the laser array imaging lens 2, the shape of the spot of light or dot that is formed on the image surface 4, can be easily changed in shape, by changing the image magnification in the above-mentioned two directions.

As mentioned above, a semiconductor laser usually outputs a light beam in which the half-width of the output light beam differs, depending on the direction. If all of the lens surfaces of the laser array imaging lens 2 are designed to be rotationally symmetric about the optical axis, the beam spot shape on the image surface will roughly correspond in shape to the shape of the output beam. However, if at least two surfaces of the laser array imaging lens are formed with an anamorphic, aspheric surface, even in the case that the beam widths from each laser element are different along the above-mentioned two directions, the shape of the beam spots on the image surface 4 can be separately adjusted in the above-mentioned two directions so as to have a desired beam spot shape.

Further, it is preferred that at least one lens component surface, among the two lens components 21 and 22, has a diffractive optical element (DOE) superimposed thereon. The diffractive optical element has a phase function (1) that is defined using Equation (C) below:

Φ=ΣCᵢ·Y²ⁱ Equation (C)

where

Y is the distance from the optical axis; and,

Cᵢ is the coefficient of Y²ⁱ.

In Embodiment 7 disclosed below containing a DOE surface, the phase function coefficients Cᵢ are zero except for i=1.

The diffractive optical element functions to add an optical path difference of λ·Φ/(2π) to the diffracted light, with the wavelength of the incident light being denoted as λ. The diffractive optical element (DOE) may be combined in a superimposed manner with the anamorphic, aspheric surface or with the aspheric surface.

Irregularities of imaging caused by fluctuations generated due to a difference in the emitted center wavelength of different laser elements can be minimized by the use of a diffractive optical element having a phase function, as mentioned above. The positional deviation of the imaged beam spots on the image surface 4 caused by a fluctuation in wavelength can be prevented despite such fluctuations of emitted light among different laser elements due to the manufacturing process as well as due to a fluctuation of emitted light due to changes in ambient temperature.

Further, as described above, the laser array imaging lens 2 functions so as to intersect the light rays that are situated at the center of each emitted beam from each laser element in a common region between the first lens component 21 and the second lens component 22. Moreover, it is preferable that a stop 3 be arranged in the vicinity of the common region, as shown in the FIGS. 1A and 1B. The arrangement of the stop 3 between the two lens components 21 and 22 enables the laser array imaging lens to generate little distortion aberration, and thus positioning errors of each beam spot on the image surface 4 can be made small.

Concerning the stop 3, it is also desirable that its geometry be independently changeable in the scanning versus the sub-scanning direction, (i.e., in the row direction versus a direction substantially perpendicular thereto), so as to be able to change the shape of the spot of light from each laser element that is imaged onto the image surface 4. Thus, the shape of the spot of light from the laser elements, Such as a circle, an ellipse, or a rectangle, on the image surface can be appropriately determined.

Further, it is desirable that the laser array imaging lens 2 be telecentric on the light-source side. Luminous fluxes emitted from the laser elements have an intensity profile that varies with emission direction, with the light intensity at the center of the beam being the greatest, and with the light intensity decreasing as the emission angle relative to the direction of peak emission becomes greater. In other words, in the case that the centers of the luminous fluxes from each laser element are parallel, it is ideal that the center of the luminous fluxes from each laser element intersect at a common region, and that the peak intensity of the luminous fluxes be directed parallel to the optical axis of the laser array imaging lens 2. In order to provide effective utilization of the light of the light source 1, the laser array imaging lens 2 is made to be telecentric on the light-source side by positioning a stop at the common region where rays from the central portion of the luminous fluxes from each laser element intersect after being refracted by the first lens component 21.

In terms of practical use, it is preferred that the angle between a ray (hereinafter called the principal ray) that passes through the center of the stop and the ray (hereinafter called the central ray) at the center of a light beam from a laser element in the light beams emergent from the laser elements in the space between the light source 1 and the laser array imaging lens 2 satisfy the following Conditions (1) and (2):

αy<θy/2 Condition (1)

αx<θx/2 Condition (2)

where

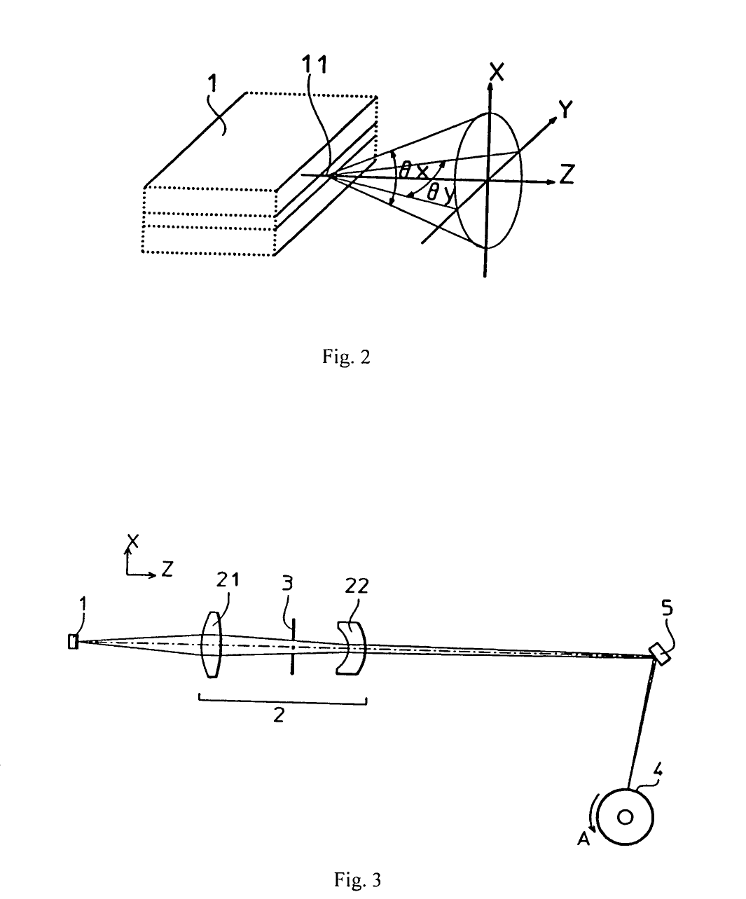

αy is the angle between the principal ray and the central ray as measured in the plane that contains the Y-Z axes, with the Y and Z axes oriented as illustrated in FIG. 2;

αx is the angle between the principal ray and the central ray as measured in the plane that contains the X-Z axes, with the X and Z axes oriented as illustrated in FIG. 2;

θy is the angle, as illustrated in FIG. 2, between the points at which the light intensity beam profile becomes 50% of the peak intensity at the center of the beam, as measured in the direction of the Y axis; and

θx is the angle, as illustrated in FIG. 2, between the points at which the light intensity beam profile becomes 50% of the peak intensity at the center of the beam, as measured in the direction of the X axis.

FIG. 2 shows a luminous flux emitted from a laser element 11, with the direction Y being the row direction of the laser elements. Furthermore, the typical ranges of the above-mentioned θy and θx are shown in FIG. 2.

It is preferable that this laser array imaging lens 2 satisfy the following Condition (3):

0.5<L/(D₂₁·(1−1/M))<2.0 Condition (3)

where

L is the distance from the semiconductor laser array light source 1 to the light-source-side surface of the first lens component 21 of the laser array imaging lens 2;

D₂₁ is the distance from the image-plane-side surface of the first lens component 21 of laser array imaging lens 2 to the position where the central rays of the beams from the laser elements intersect the optical axis; and

M is the image magnification.

The stop 3 is arranged substantially at the distance D₂₁ from the image-plane-side surface of the first lens component 21 of the laser array imaging lens. The satisfaction of Condition (3) by the laser array imaging lens 2 results in more favorable correction of aberrations while maintaining the telecentric property of the laser array imaging lens on the light-source side.

By satisfying the above Condition (3), the laser array imaging lens 2 can more favorably correct aberrations while being substantially telecentric on the light-source side. If the lower limit of Condition (3) is not satisfied, it becomes difficult to favorably correct various aberrations such as curvature of field and coma. If the upper limit of Condition (3) is not satisfied, it also becomes difficult to favorably correct various aberrations such as curvature of field and coma.

In the embodiments shown below, a desirable design balance is achieved by additionally satisfying the following Condition (4):

0.8<L/(D₂₁·(1−1/M))<1.7 Condition (4)

where L, D₂₁ and M are as defined above. However, the upper and lower limits of Condition (4) are not strictly defined, as they may vary with design conditions, such as the amount of image magnification M, etc.

It also is possible to use either optical glass or plastic as the lens material of the laser array imaging lens 2. Plastic is preferred since it is less costly to process or to mold, especially when the laser array imaging lens is made to have a long rectangular shape in the direction that the laser elements are arrayed so as to receive beams emergent from the semiconductor laser array light source 1 arrayed with the laser elements in rows.

A so-called “composite aspheric lens” component in which a thin plastic layer is provided at the surface of a spherical lens element that is made of a glass material can also be used as the aspheric lens in this invention.

The image-forming device of the present invention is not restricted to one of the above embodiments, and various changes of mode or addition of functions are possible. For example, a construction in which a mirror 5 is arranged in the optical path in order to fold the light so as to make the image-forming device fit within a particular dimensional restriction may also be adopted, as shown in FIG. 3.

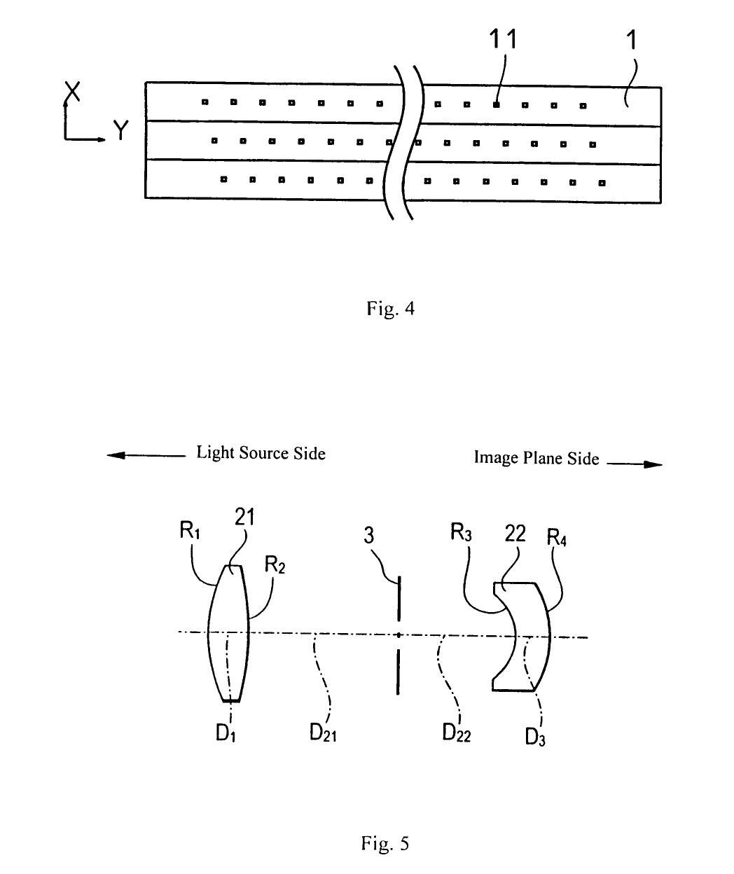

As shown in FIG. 4, the semiconductor laser array light source 1 made by arraying multiple laser elements in a row is not limited to there being a single row, as multiple laser element rows for high speed printing, high-density of dots, etc, may be used. For example, FIG. 4 is an example of a semiconductor laser array light source 1 having three laser element rows made by arraying multiple laser elements 11 in rows. The laser elements 11 of each row are shifted in the direction of the row an amount equal to ⅓ of the pitch of the laser element pitch in the Y direction. Preferably, the amount that the laser elements in different rows are shifted is equal to the distance between the laser elements in a given row divided by the number of rows in the array, so as to make uniform the distance between the laser elements in the semiconductor laser array light source 1 that is provided with multiple laser element rows.

It is also possible to arrange the surface of the laser elements of the semiconductor laser array light source 1 into a prescribed circular arc with a concave shape toward the laser array imaging lens 2 by facing the laser elements toward the laser array imaging lens 2. Thus, it is possible to effectively guide directional beams from the semiconductor laser array light source 1 to the pupil of the laser array imaging lens 2 without requiring a telecentric system such as discussed above. Even if the laser elements of the semiconductor laser array light source 1 are not arrayed into a circular arc of a concave shape as described above, the same effects are obtained if, as both ends of the semiconductor laser array are approached, the laser elements are increasingly angled inward so that the direction of the light emission of each is toward the optical axis of the laser array imaging lens 2.

Moreover, the number of laser elements of the semiconductor laser array light source 1 may be varied by selecting whatever number is appropriate for a particular intended purpose. For example, if the illumination at the ends of the scanning line on the surface to be scanned is lower than at the center of the scanning line (i.e., on the optical axis), it is possible to achieve a greater uniformity of illumination of the scanned surface by adjusting the output intensity of the laser elements of the semiconductor laser array light source 1. In addition, the number of the semiconductor laser elements in the semiconductor laser array light source 1 is not limited to the above-mentioned embodiment, and it is possible to appropriately change the number of the laser elements to be arranged, depending upon the use or application.

Furthermore, in the image-forming device of the present invention, a parallel-plate cover glass or a filter that is made of glass or plastic can be arranged between the semiconductor laser array light source 1 and the image surface 4 so as to protect the surface to be scanned and/or prevent dust from obscuring one or more pixels. Also, a very small lens can be arranged close to the light source to properly adjust the expansion angle of the beams in one direction, thereby compensating for the astigmatic difference of the light beams emitted from the laser elements.

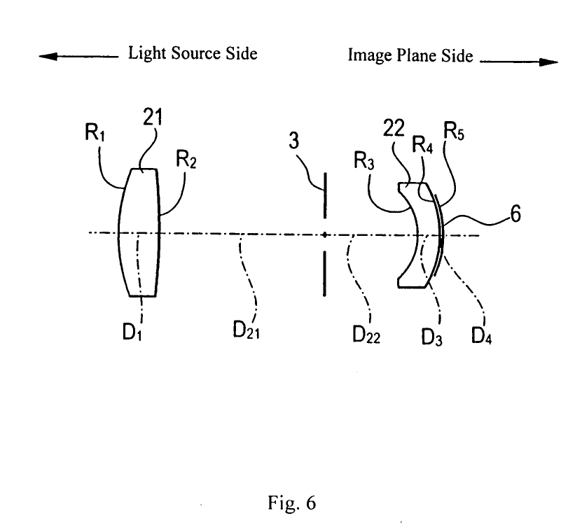

Eight specific embodiments of the laser array imaging lens according to the present invention will now be set forth in detail. Further, FIG. 5 shows a typical construction of the laser array imaging lens relating to Embodiments 1 through 7, and FIG. 6 shows a typical construction of the laser array imaging lens relating to Embodiment 8.

### EMBODIMENT 1

The laser array imaging lens according to the present embodiment is formed of two lens components. In order from the light-source side these are: a first lens component 21 having both surfaces aspheric and a second lens component 22 having both surfaces aspheric. Further, due to the function of the first lens component 21, light beams situated in the vicinity of the center of each luminous flux from each laser element of the laser array light source intersect at a common region that is substantially a single point on the optical axis of the laser array imaging lens, and the stop 3 is arranged at this common region so that the laser array imaging lens is telecentric on the light-source side.

Table 1 below lists the surface number # of each lens element surface, in order from the light-source side, the radius of curvature R (in mm) near the optical axis of each optical surface, the on-axis spacing D (in mm) between surfaces, the index of refraction N₇₈₀ of the optical material of each lens element as measured at a wavelength of 780 nm, and the Abbe number ν_{d} (measured relative to the d-line) of the optical material of each lens element of Embodiment 1. Those surfaces in Table 1 having a * to the right of the surface number are aspheric. The middle portion of Table 1 lists for this embodiment the focal length f₁ of the first lens component, the focal length f₂ of the second lens component, the overall focal length f of the laser array imaging lens, the f-number F_{NO} of the laser array imaging lens, the distance L from the semiconductor laser array light source to the light-source-side surface of the first lens component, the overall thickness D′ of the laser array imaging lens, the distance L′ from the image-plane-side surface of the second lens component to a scanned surface at the image plane of the laser array imaging lens, the image magnification M, the total combined length TCL of the image-forming device as measured from the semiconductor laser array light source to a scanned surface located at the image plane of the laser array imaging lens, as well as the value of L/(D₂₁·(1−1/M)) corresponding to the above Condition (3). The lower portion of the table lists the constant K as well as the coefficients A₄, A₆, A₈ and A₁₀ used in Equation (A) above for the aspheric lens surfaces #1-#4 of the laser array imaging lens according to this embodiment. An “E” in the data indicates that the number following the “E” is the exponent to the base 10. For example, “1.0E-2” represents the number 1.0×10⁻².

TABLE 1

| # | R | D | N_{780 nm} | ν_{d} |
|---|---|---|---|---|
| 1* | 41.3581 | 14.0000 | 1.70400 | 53.9 |
| 2* | 96.1091 | 80.2256 (D₂₁) | | |
| | ∞ (stop) | 20.0000 (D₂₂) | | |
| 3* | 22.7742 | 16.3000 | 1.70400 | 53.9 |
| 4* | 18.5425 | | | |

| | | | |
|---|---|---|---|
| f₁ = 93.270 | f₂ = 239.689 | f = 72.882 | F_{NO} = 50.000 |
| L = 79.131 | D′ = 130.526 | L′ = 598.587 | M = −8.467 |

| | |
|---|---|
| TCL = 808.244 | L/(D₂₁ · (1 − 1/M)) = 0.882 |

| | Aspheric | Aspheric | Aspheric | Aspheric |
|---|---|---|---|---|
| | #1 | #2 | #3 | #4 |
| K | 7.9193E−1 | 4.0861 | 4.5833E−1 | 5.7476E−1 |
| A₄ | −6.3007E−7 | 3.7459E−7 | −2.2274E−7 | −5.2749E−8 |
| A₆ | −1.5000E−13 | −3.1393E−12 | 1.7811E−11 | −1.3447E−11 |
| A₈ | 3.7557E−15 | −1.3213E−15 | 0.0000 | 0.0000 |
| A₁₀ | 1.5283E−19 | −3.6561E−20 | 0.0000 | 0.0000 |

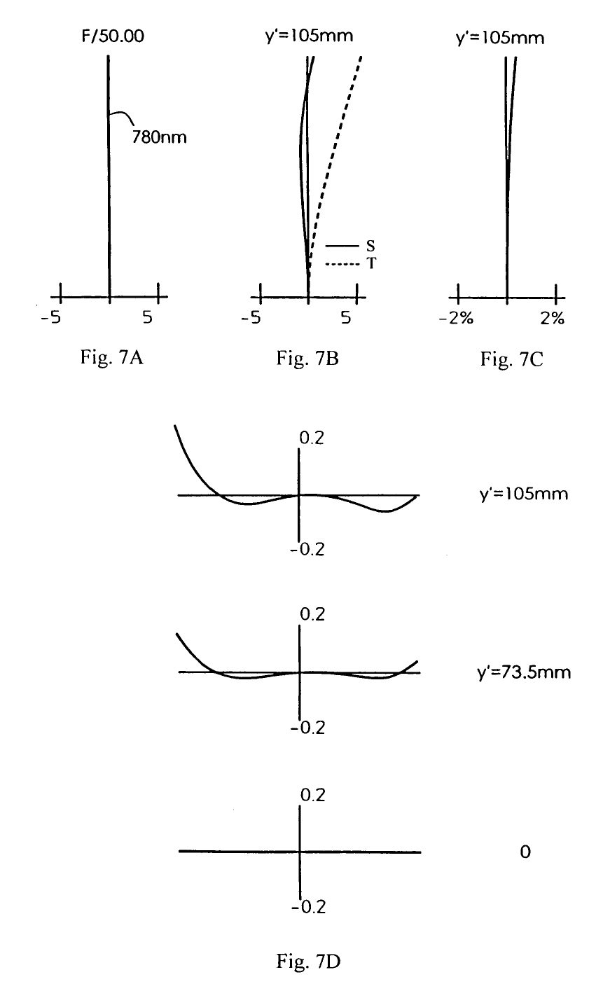

FIGS. 7A-7C show the spherical aberration, astigmatism, and distortion, respectively, for this embodiment at a wavelength of 780 nm. The spherical aberration (in mm), the astigmatism (in mm) for both the sagittal S and tangential T image surface, and the distortion are shown. The f-number F_{NO} of this embodiment is listed in FIG. 7A and the maximum ray height y′=105 mm is listed in FIGS. 7B-7C. FIG. 7D shows the coma (in mm) for ray heights y′ of zero, 73.5 mm and 105 mm. As is evident from FIGS. 7A-7D, all these aberrations are favorably corrected for a wavelength of 780 nm.

### EMBODIMENT 2

The laser array imaging lens according to the Embodiment 2 is formed of two lens components. In order from the light-source side these are: a first lens component 21 having both surfaces aspheric and a second lens component 22 having both surfaces aspheric, similar to the arrangement of Embodiment 1. Further, similar to the laser array imaging lens in Embodiment 1, a stop 3 is positioned on the optical axis of the laser array imaging lens substantially at the back focal plane of the first lens component so that the laser array imaging lens is telecentric on the light-source side.

Table 2 below lists the surface number # of each lens element surface in order from the light-source side, the radius of curvature R (in mm) near the optical axis of each optical surface, the on-axis spacing D (in mm) between surfaces, the index of refraction N₇₈₀ of the optical material of each lens element as measured at a wavelength of 780 nm, and the Abbe number ν_{d} (measured relative to the d-line) of the optical material of each lens element of Embodiment 2. Those surfaces in Table 2 having a * to the right of the surface number are aspheric. The middle portion of Table 2 lists for this embodiment the focal length f₁ of the first lens component, the focal length f₂ of the second lens component, the overall focal length f of the laser array imaging lens, the f-number F_{NO} of the laser array imaging lens, the distance L from the semiconductor laser array light source to the light-source-side surface of the first lens component, the overall thickness D′ of the laser array imaging lens, the distance L′ from image-plane-side surface of the second lens component to a scanned surface at the image plane of the laser array imaging lens, the image magnification M, the total combined length TCL of the image-forming device as measured from the semiconductor laser array light source to a scanned surface located at the image plane of the laser array imaging lens, as well as the value of L/(D₂₁·(1−1/M)) corresponding to the above Condition (3). The lower portion of the table lists the constant K as well as the aspheric coefficients A₄, A₆, A₈ and A₁₀ of the aspheric lens surfaces listed for the laser array imaging lens according to this embodiment. An “E” in the data indicates that the number following the “E” is the exponent to the base 10. For example, “1.0E-2” represents the number 1.0×10⁻².

TABLE 2

| # | R | D | N_{780 nm} | ν_{d} |
|---|---|---|---|---|
| 1* | 47.282 | 14.0000 | 1.57166 | 30.3 |
| 2* | −152.861 | 57.838 (D₂₁) | | |
| | ∞ (stop) | 25.721 (D₂₂) | | |
| 3* | −15.222 | 16.300 | 1.57166 | 30.3 |
| 4* | −26.599 | | | |

| | | | |
|---|---|---|---|
| f₁ = 64.820 | f₂ = −130.014 | f = 66.486 | F_{NO} = 50.000 |
| L = 103.661 | D′ = 113.859 | L′ = 515.623 | M = −8.467 |

| | |
|---|---|
| TCL = 733.1426 | L/(D₂₁ · (1 − 1/M)) = 1.603 |

| | Aspheric | Aspheric | Aspheric | Aspheric |
|---|---|---|---|---|
| | #1 | #2 | #3 | #4 |
| K | 4.4448E−1 | 3.4849 | 5.9512E−1 | 7.4313E−1 |
| A₄ | −6.0486E−7 | 5.9000E−7 | −2.4260E−8 | 2.7887E−7 |
| A₆ | −6.2050E−12 | 2.2359E−12 | 1.4444E−11 | −2.1893E−11 |
| A₈ | 2.5528E−15 | −4.4633E−16 | 0.0000 | 0.0000 |
| A₁₀ | 1.1188E−19 | −9.8838E−21 | 0.0000 | 0.0000 |

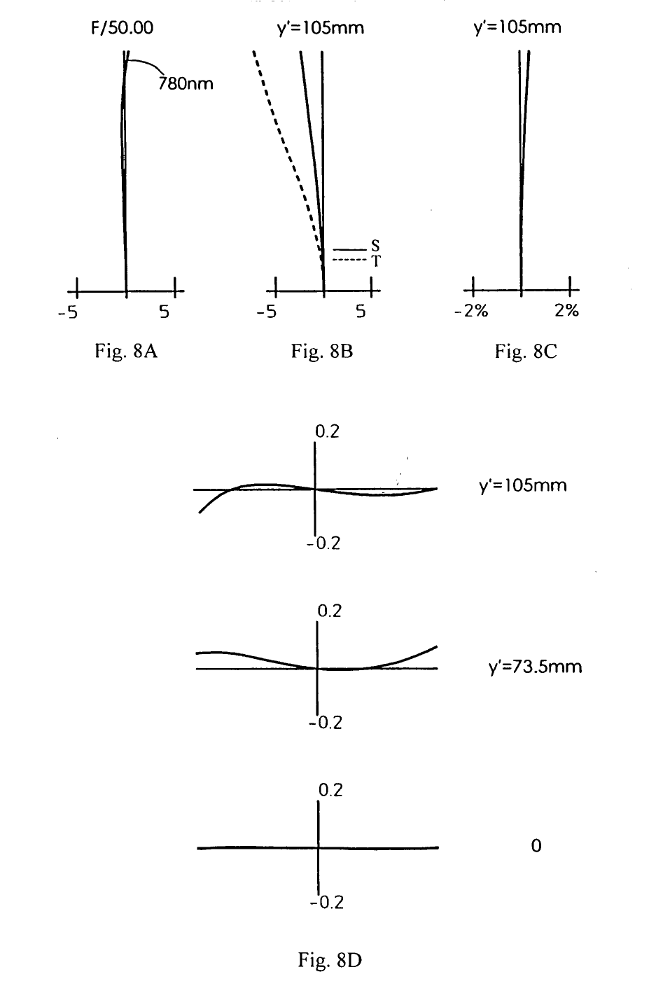

FIGS. 8A-8C show the spherical aberration, astigmatism, and distortion, respectively, for this embodiment at a wavelength of 780 nm. The spherical aberration (in mm), the astigmatism (in mm) for both the sagittal S and tangential T image surface, and the distortion are shown. The f-number F_{NO} Of this embodiment is listed in FIG. 8A and the maximum ray height y′=105 mm is listed in FIGS. 8B-8C. FIG. 8D shows the coma (in mm) for ray heights y′ of zero, 73.5 mm and 105 mm. As is evident from FIGS. 8A-8D, all these aberrations are favorably corrected for a wavelength of 780 nm.

### EMBODIMENT 3

The laser array imaging lens according to the Embodiment 3 is formed of two lens components. In order from the light-source side these are: a first lens component 21 having both surfaces aspheric and a second lens component 22 having both surfaces aspheric, similar to the arrangement of Embodiment 1. Further, similar to the laser array imaging lens in Embodiment 1, a stop 3 is positioned on the optical axis of the laser array imaging lens substantially at the back focal plane of the first lens component so that the laser array imaging lens is telecentric on the light-source side.

Table 3 below lists the surface number # of each lens element surface in order from the light-source side, the radius of curvature R (in mm) near the optical axis of each optical surface, the on-axis spacing D (in mm) between surfaces, the index of refraction N₇₈₀ of the optical material of each lens element as measured at a wavelength of 780 nm, and the Abbe number ν_{d} (measured relative to the d-line) of the optical material of each lens element of Embodiment 3. Those surfaces in Table 3 having a * to the right of the surface number are aspheric. The middle portion of Table 3 lists for this embodiment the focal length f₁ of the first lens component, the focal length f₂ of the second lens component, the overall focal length f of the laser array imaging lens, the f-number F_{NO} of the laser array imaging lens, the distance L from the semiconductor laser array light source to the light-source-side surface of the first lens component, the overall thickness D′ of the laser array imaging lens, the distance L′ from image-plane-side surface of the second lens component to a scanned surface at the image plane of the laser array imaging lens, the image magnification M, the total combined length TCL of the image-forming device as measured from the semiconductor laser array light source to a scanned surface located at the image plane of the laser array imaging lens, as well as the value of L/(D₂₁·(1−1M)) corresponding to the above Condition (3). The lower portion of the table lists the constant K as well as the aspheric coefficients A₄, A₆, A₈ and A₁₀ of the aspheric lens surfaces listed for the laser array imaging lens according to this embodiment. An “E” in the data indicates that the number following the “E” is the exponent to the base 10. For example, “1.0E-2” represents the number 1.0×10⁻².

TABLE 3

| # | R | D | N_{780 nm} | ν_{d} |
|---|---|---|---|---|
| 1* | 53.322 | 14.0000 | 1.57166 | 30.3 |
| 2* | −67.732 | 55.492 (D₂₁) | | |
| | ∞ (stop) | 44.235 (D₂₂) | | |
| 3* | −16.818 | 12.000 | 1.57166 | 30.3 |
| 4* | −37.707 | | | |

| | | | |
|---|---|---|---|
| f₁ = 54.48085 | f₂ = −67.131 | f = 33.306 | F_{NO} = 50.000 |
| L = 81.349 | D′ = 125.728 | L′ = 238.4799 | M = −8.467 |

| | |
|---|---|
| TCL = 445.556 | L/(D₂₁ · (1 − 1/M)) = 1.311 |

| | Aspheric | Aspheric | Aspheric | Aspheric |
|---|---|---|---|---|
| | #1 | #2 | #3 | #4 |
| K | 2.1531E−1 | 1.1435 | 6.0830E−1 | 9.7960E−1 |
| A₄ | −9.9749E−7 | 1.3480E−6 | 1.3367E−7 | −2.8209E−7 |
| A₆ | 1.0270E−10 | −1.1032E−10 | 1.1296E−11 | 1.1905E−11 |
| A₈ | 3.5022E−15 | −1.0021E−15 | 0.0000 | 0.0000 |
| A₁₀ | 3.4580E−20 | 8.0698E−20 | 0.0000 | 0.0000 |

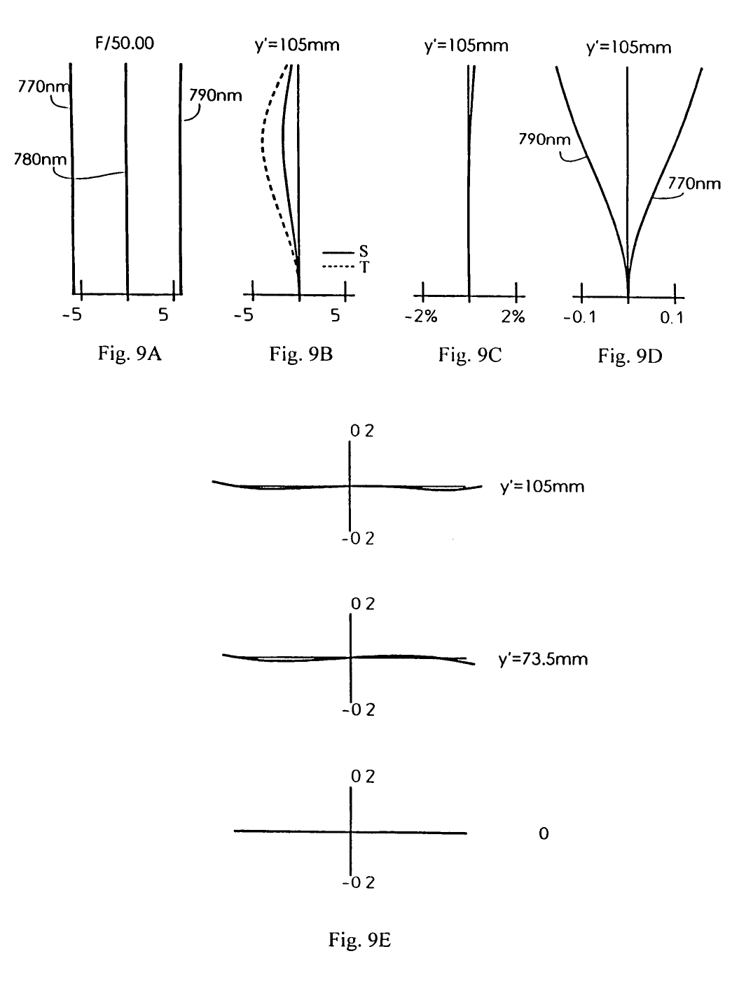

FIGS. 9A-9D show the spherical aberration, astigmatism, distortion, and lateral color, respectively, for this embodiment at a wavelength of 780 nm. The spherical aberration (in mm) and lateral color (in mm) are also shown for wavelengths 770 and 790 nm. The astigmatism (in mm) is shown for both the sagittal S and tangential T image surfaces. The f-number F_{NO} of this embodiment is listed in FIG. 9A and the maximum ray height y′=105 mm is listed in FIGS. 9B-9D. FIG. 9E shows the coma (in mm) for ray heights y′ of zero, 73.5 mm and 105 mm. As is evident from FIGS. 9A-9E, all these aberrations are favorably corrected for a wavelength of 780 nm.

### EMBODIMENT 4

The laser array imaging lens according to the Embodiment 4 is formed of two lens components. In order from the light-source side these are: a first lens component 21 having both surfaces (surface #1 and surface #2) aspheric and a second lens component 22 having both surfaces spherical instead of being aspheric. A stop 3 is positioned on the optical axis of the laser array imaging lens substantially at the back focal plane of the first lens component so that the laser array imaging lens is telecentric on the light-source side.

Table 4 below lists the surface number # of each lens element surface in order from the light-source side, the radius of curvature R (in mm) near the optical axis of each optical surface, the on-axis spacing D (in mm) between surfaces, the index of refraction N₇₈₀ of the optical material of each lens element as measured at a wavelength of 780 nm, and the Abbe number ν_{d} (measured relative to the d-line) of the optical material of each lens element of Embodiment 4. Those surfaces in Table 4 having a * to the right of the surface number are aspheric. The middle portion of Table 4 lists for this embodiment the focal length f₁ of the first lens component, the focal length f₂ of the second lens component, the overall focal length f of the laser array imaging lens, the f-number F_{NO} of the laser array imaging lens, the distance L from the semiconductor laser array light source to the light-source-side surface of the first lens component, the overall thickness D′ of the laser array imaging lens, the distance L′ from image-plane-side surface of the second lens component to a scanned surface at the image plane of the laser array imaging lens, the image magnification M, the total combined length TCL of the image-forming device as measured from the semiconductor laser array light source to a scanned surface located at the image plane of the laser array imaging lens, as well as the value of L/(D₂₁·(1−1/M)) corresponding to the above Condition (3). The lower portion of the table lists the constant K as well as the aspheric coefficients A₄, A₆, A₈ and A₁₀ in Equation (A) above for the aspheric lens surfaces #1 and #2 of the laser array imaging lens according to this embodiment. An “E” in the data indicates that the number following the “E” is the exponent to the base 10. For example, “1.0E-2” represents the number 1.0×10⁻².

TABLE 4

| # | R | D | N_{780 nm} | ν_{d} |
|---|---|---|---|---|
| 1* | 51.113 | 14.0000 | 1.70400 | 53.9 |
| 2* | −188.676 | 51.911 (D₂₁) | | |
| | ∞ (stop) | 30.199 (D₂₂) | | |
| 3 | −16.578 | 18.000 | 1.70400 | 53.9 |
| 4 | −26.672 | | | |

| | | | |
|---|---|---|---|
| f₁ = 58.540 | f₂ = −236.339 | f = 68.956 | F_{NO} = 50.000 |
| L = 81.969 | D′ = 114.110 | L′ = 519.851 | M = −8.467 |

| | |
|---|---|
| TCL = 715.931 | L/(D₂₁ · (1 − 1/M)) = 1.412 |

| | Aspheric | Aspheric |
|---|---|---|
| | #1 | #2 |
| K | 3.7944E−1 | 4.5737 |
| A₄ | −5.4464E−7 | 5.0620E−7 |
| A₆ | 8.9963E−12 | −1.1767E−11 |
| A₈ | 5.8288E−16 | 1.3204E−15 |
| A₁₀ | 2.5253E−20 | 6.0671E−20 |

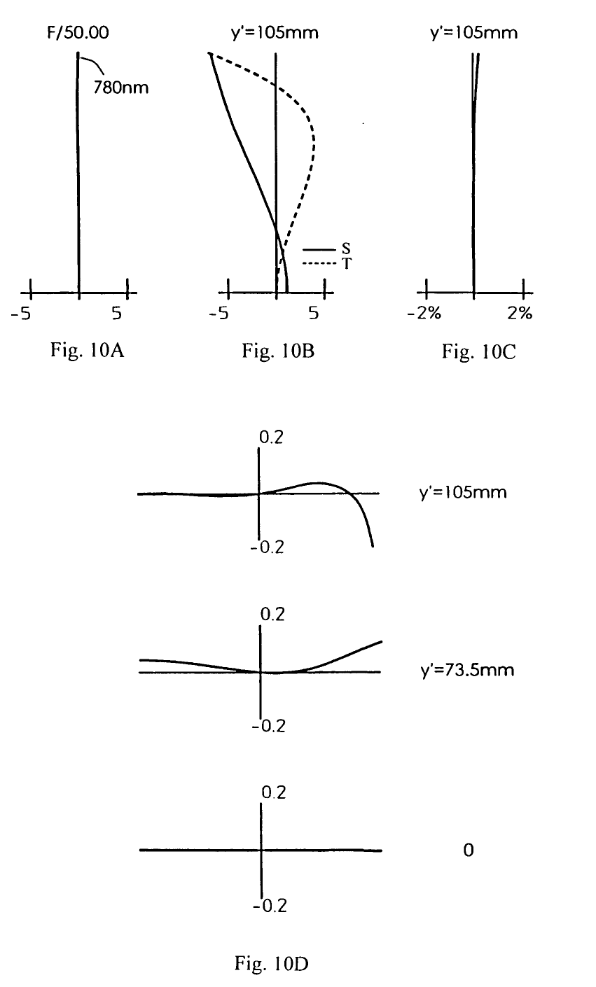

FIGS. 10A-10C show the spherical aberration, astigmatism, and distortion, respectively, for this embodiment at a wavelength of 780 nm. The spherical aberration (in mm), the astigmatism (in mm) for both the sagittal S and tangential T image surface, and the distortion are shown. The f-number F_{NO} of this embodiment is listed in FIG. 10A and the maximum ray height y′=105 mm is listed in FIGS. 10B-10C. FIG. 10D shows the coma (in mm) for ray heights y′ of zero, 73.5 mm and 105 mm. As is evident from FIGS. 10A-10D, all these aberrations are favorably corrected for a wavelength of 780 nm.

### EMBODIMENT 5

The laser array imaging lens according to the present embodiment is formed of two lens components. In order from the light-source side these are: a first lens component 21 having an anamorphic, aspheric surface on its light-source side (surface # 1) and having an aspheric surface on its other side (surface #2), and a second lens component 22 having its light-source side surface (surface # 3) aspheric and its other side (surface #4) formed as an anamophic, aspheric surface. Further, due to the function of the first lens component 21, light beams situated in the vicinity of the center of each luminous flux from each laser element of the laser array light source intersect at a common region that is substantially a single point on the optical axis of the laser array imaging lens, and the stop 3 is arranged at this common region so that the laser array imaging lens is telecentric on the light-source side.

Table 5 below lists the surface number # of each lens element surface in order from the light-source side, the radius of curvature R (in mm) near the optical axis of each optical surface, the on-axis spacing D (in mm) between surfaces, the index of refraction N₇₈₀ of the optical material of each lens element as measured at a wavelength of 780 nm, and the Abbe number ν_{d} (measured relative to the d-line) of the optical material of each lens element of Embodiment 5. Those surfaces in Table 5 having a * to the right of the surface number are aspheric. The middle portion of Table 5 lists for this embodiment the focal length f₁ of the first lens component, the focal length f₂ of the second lens component, the overall focal length f of the laser array imaging lens, the f-number F_{NO} of the laser array imaging lens, the distance L from the semiconductor laser array light source to the light-source-side surface of the first lens component, the overall thickness D′ of the laser array imaging lens, the distance L′ from the image-plane-side surface of the second lens component to a scanned surface at the image plane of the laser array imaging lens, the image magnification M, the total combined length TCL of the image-forming device as measured from the semiconductor laser array light source to a scanned surface located at the image plane of the laser array imaging lens, as well as the value of L/(D₂₁·(1−1/M)) corresponding to the above Condition (3). The lower portion of the Table lists the values of CR, K_{AX}, K_{AY}, A₄, K₂, A₆, K₃, A₈, K₄, A₁₀ and K₅ used in Equation (B) above for the anamorphic, aspheric surfaces #1 and #4 as well as the values of K, A₄, A₆, A₈ and A₁₀ used in Equation (A) above for the aspheric lens surfaces #2 and #3 of the laser array imaging lens according to this embodiment. An “E” in the data indicates that the number following the “E” is the exponent to the base 10. For example, “1.0E-2” represents the number 1.0×10⁻².

TABLE 5

| # | R | D | N_{780 nm} | ν_{d} |
|---|---|---|---|---|
| 1* | 47.282 | 14.000 | 1.57166 | 30.3 |
| 2* | −152.861 | 57.838(D₂₁) | | |
| | ∞ (stop) | 25.721 (D₂₂) | | |
| 3* | −15.222 | 16.300 | 1.57166 | 30.3 |
| 4* | −26.599 | | | |

| | | | |
|---|---|---|---|
| f₁ = 64.820 | f₂ = −130.014 | f = 66.486 | F_{NO} = 50.000 |
| L = 103.661 | D′ = 113.859 | L′ = 515.623 | M = −8.467 |

| | |
|---|---|
| TCL = 733.143 | L/(D₂₁ · (1 − 1/M)) = 1.603 |

| | Anamorphic, Aspheric Surfaces | | | Aspheric Surfaces | |
|---|---|---|---|---|---|
| | #1 | #4 | | #2 | #3 |
| CR | 2.2222E−2 | −3.3959E−2 | K | 3.4849 | 5.9512E−1 |
| K_{AX} | −1.5393E−1 | 8.9973E−1 | A₄ | 5.9000E−7 | −2.4260E−8 |
| K_{AY} | 2.5909E−1 | 7.3747E−1 | A₆ | 2.2359E−12 | 1.4444E−11 |
| A₄ | −1.7921E−7 | 5.8627E−8 | A₈ | −4.4633E−16 | 0.0000 |
| K₂ | 4.7973E−1 | 9.3576E−1 | A₁₀ | −9.8838E−21 | 0.0000 |
| A₆ | 4.0526E−12 | −3.1499E−13 | | | |
| K₃ | 1.6947 | 1.0058 | | | |
| A₈ | −1.6911E−16 | 5.2805E−19 | | | |
| K₄ | 3.7025 | 1.0000 | | | |
| A₁₀ | −4.6309E−23 | 5.8168E−27 | | | |
| K₅ | 1.0007 | 1.0000 | | | |

FIGS. 11A-11C show the spherical aberration, astigmatism, and distortion, respectively, for this embodiment at a wavelength of 780 nm. The spherical aberration (in mm), the astigmatism (in mm) for both the sagittal S and tangential T image surfaces, and the distortion are shown. The f-number F_{NO} of this embodiment is listed in FIG. 11A and the maximum ray height y′=105 mm is listed in FIGS. 11B-11C. FIG. 11D shows the coma (in mm) for ray heights y′ of zero, 73.5 mm and 105 mm. As is evident from FIGS. 11A-11D, all these aberrations are favorably corrected for a wavelength of 780 nm.

### EMBODIMENT 6

The laser array imaging lens according to the present embodiment is formed of two lens components. In order from the light-source side these are: a first lens component 21 having an anamorphic, aspheric surface on its light-source side (surface # 1) and having an aspheric surface on its other side (surface #2), and a second lens component 22 having both surfaces spherical. Further, due to the function of the first lens component 21, light beams situated in the vicinity of the center of each luminous flux from each laser element of the laser array light source intersect at a common region that is substantially a single point on the optical axis of the laser array imaging lens, and the stop 3 is arranged at this common region so that the laser array imaging lens is telecentric on the light-source side.

Table 6 below lists the surface number # of each lens element surface in order from the light-source side, the radius of curvature R (in mm) near the optical axis of each optical surface, the on-axis spacing D (in mm) between surfaces, the index of refraction N₇₈₀ of the optical material of each lens element as measured at a wavelength of 780 nm, and the Abbe number ν_{d} measured relative to the d-line of the optical material of each lens element of Embodiment 6. Those surfaces in Table 6 having a * to the right of the surface number are aspheric. The middle portion of Table 6 lists the focal length f₁ of the first lens component, the focal length f₂ of the second lens component, the overall focal length f of the laser array imaging lens, the f-number F_{NO} of the laser array imaging lens, the distance L from the semiconductor laser array light source to the light-source-side surface of the first lens component, the overall thickness D′ of the laser array imaging lens, the distance L′ from the image-plane-side surface of the second lens component to a scanned surface at the image plane of the laser array imaging lens, the image magnification M, the total combined length TCL of the image-forming device as measured from the semiconductor laser array light source to the scanned surface, as well as the value of L/(D₂₁·(1−1/M)) corresponding to the above Condition (3). The lower portion of the table lists, for surface #1, the values of CR, K_{AX}, K_{AY}, A₄, K₂, A₆, K₃, A₈, K₄, A₁₀ and K₅ used in Equation (B) above and, for surface #2, the values of K, A₄, A₆, A₈ and A₁₀ used in Equation (A) above for the laser array imaging lens according to this embodiment. An “E” in the data indicates that the number following the “E” is the exponent to the base 10. For example, “1.0E-2” represents the number 1.0×10⁻².

TABLE 6

| # | R | D | N_{780 nm} | ν_{d} |
|---|---|---|---|---|
| 1* | 44.045 | 14.000 | 1.57166 | 30.3 |
| 2* | −149.774 | 54.076(D₂₁) | | |
| | ∞ (stop) | 19.621 (D₂₂) | | |
| 3 | −17.907 | 16.300 | 1.57166 | 30.3 |
| 4 | −26.706 | | | |

| | | | |
|---|---|---|---|
| f₁ = 61.145 | f₂ = −291.509 | f = 72.335 | F_{NO} = 50.000 |
| L = 82.782 | D′ = 103.997 | L′ = 569.271 | M = −8.467 |

| | |
|---|---|
| TCL = 756.050 | L/(D₂₁ · (1 − 1/M)) = 1.369 |

| | Anamorphic, Aspheric Surface | | Aspheric Surface |
|---|---|---|---|
| | #1 | | #2 |
| CR | 2.2700E−2 | K | 3.3327 |
| K_{AX} | −1.1901E−1 | A₄ | 6.7184E−7 |
| K_{AY} | 1.7320E−1 | A₆ | −4.0727E−12 |
| A₄ | −1.7835E−7 | A₈ | −5.7723E−16 |
| K₂ | 5.5118E−1 | A₁₀ | −1.7031E−20 |
| A₆ | 2.5875E−11 | | |
| K₃ | 1.8093 | | |
| A₈ | −1.4659E−15 | | |
| K₄ | 3.7303 | | |
| A₁₀ | 2.3090E−19 | | |
| K₅ | 1.0176 | | |

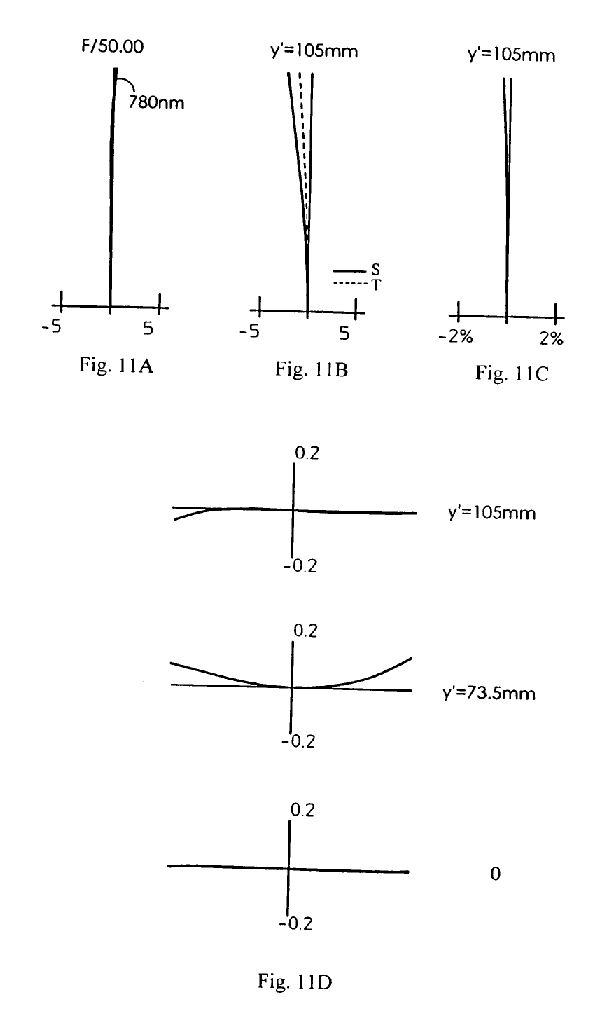

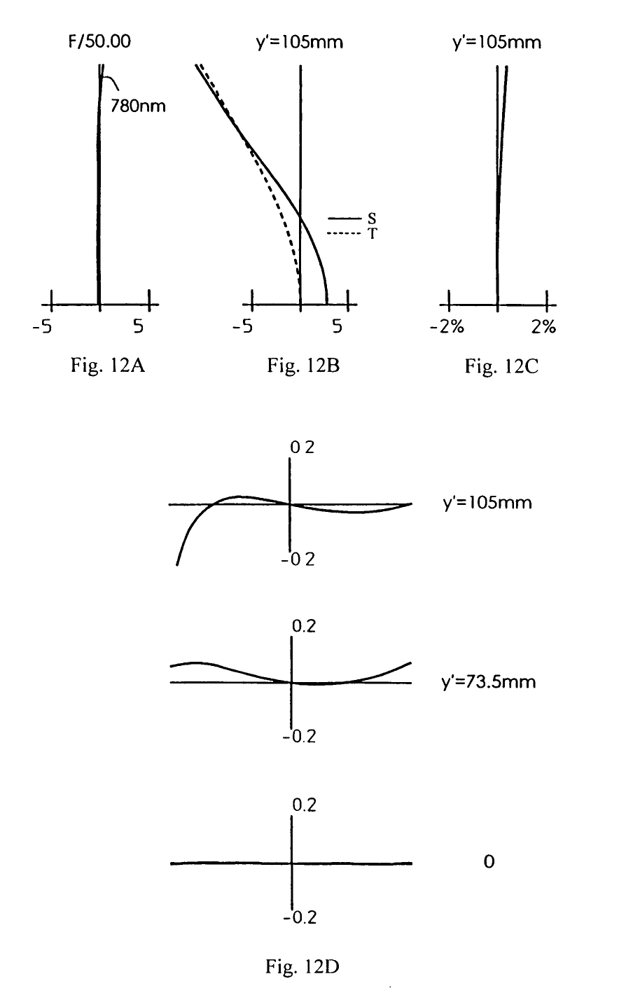

FIGS. 12A-12C show the spherical aberration, astigmatism, and distortion, respectively, for this embodiment at a wavelength of 780 nm. The spherical aberration (in mm), the astigmatism (in mm) for both the sagittal S and tangential T image surfaces, and the distortion are shown. The f-number F_{NO} of this embodiment is listed in FIG. 12A and the maximum ray height y′=105 mm is listed in FIGS. 12B-12C. FIG. 12D shows the coma (in mm) for ray heights y′ of zero, 73.5 mm and 105 mm. As is evident from FIGS. 12A-12D, all these aberrations are favorably corrected for a wavelength of 780 nm.

### EMBODIMENT 7

The laser array imaging lens according to the present embodiment is formed of two lens components. In order from the light-source side these are: a first lens component 21 having an aspheric surface with a diffractive optical element DOE having a phase function (as per Equation (C) above) superimposed thereon on its light-source side (surface # 1) and having an aspheric surface on its other side (surface #2), and a second lens component 22 having two aspheric surfaces. Further, due to the function of the first lens component 21, light beams situated in the vicinity of the center of each luminous flux from each laser element of the laser array light source intersect at a common region that is substantially a single point on the optical axis of the laser array imaging lens, and the stop 3 is arranged at this common region so that the laser array imaging lens is telecentric on the light-source side.

Table 7 below lists the surface number # of each lens element surface in order from the light-source side, the radius of curvature R (in mm) near the optical axis of each optical surface, the on-axis spacing D (in mm) between surfaces, the index of refraction N₇₈₀ of the optical material of each lens element as measured at a wavelength of 780 nm, and the Abbe number ν_{d} measured relative to the d-line of the optical material of each lens element of Embodiment 7. Those surfaces in Table 7 having a * to the right of the surface number are aspheric. The middle portion of Table 7 lists the focal length f₁ of the first lens component, the focal length f₂ of the second lens component, the overall focal length f of the laser array imaging lens, the f-number F_{NO} of the laser array imaging lens of this embodiment, the distance L from the semiconductor laser array light source to the light-source-side surface of the first lens component, the overall thickness D′ of the laser array imaging lens, the distance L′ from the image-plane-side surface of the second lens component to a scanned surface at the image plane of the laser array imaging lens, the image magnification M, the total combined length TCL of the image-forming device as measured from the semiconductor laser array light source to a scanned surface located at the image plane of the laser array imaging lens, as well as the value of L/(D₂₁·(1−1/M)) corresponding to the above Condition (3). The lower portion of the table lists, for surface #1, the values of K, A₄, A₆, A₈ and A₁₀ used in Equation (A) above, as well as the value of C₁ used in Equation (C) above for the superimposed DOE surface according to this embodiment, and for surfaces #2, #3, and #4, the values of the constant K and the coefficients A₄, A₆, A₈, and A₁₀ used in Equation (A) above for this embodiment. An “E” in the data indicates that the number following the “E” is the exponent to the base 10. For example, “1.0E-2” represents the number 1.0×10⁻².

TABLE 7

| # | R | D | N_{780 nm} | ν_{d} |
|---|---|---|---|---|
| 1* | 53.070 | 14.000 | 1.57166 | 30.3 |
| 2* | −60.299 | 44.052 (D₂₁) | | |
| | ∞ (stop) | 49.996 (D₂₂) | | |
| 3* | −16.799 | 12.000 | 1.57166 | 30.3 |
| 4* | −35.546 | | | |

| | | | |
|---|---|---|---|
| f₁= 51.699 | f₂ = −72.632 | f = 31.452 | F_{NO} = 50.000 |
| L = 70.119 | D′ = 120.048 | L′ = 221.188 | M = −8.467 |

| | |
|---|---|
| TCL = 411.355 | L/(D₂₁ · (1 − 1/M)) = 1.424 |

| | DOE, aspheric | Aspheric | Aspheric | Aspheric |
|---|---|---|---|---|
| | surface | surface | Surface | Surface |
| | #1 | #2 | #3 | #4 |
| K | −6.5493E−1 | 1.2598 | 5.9031E−1 | 8.3114E−1 |
| A₄ | −8.8304E−7 | 1.6202E−6 | 2.2740E−7 | −5.3881E−7 |
| A₆ | 1.4045E−10 | −1.5590E−10 | 9.2582E−12 | 2.5521E−11 |
| A₈ | 4.4624E−15 | −2.1992E−15 | 0.0000 | 0.0000 |
| A₁₀ | 5.7609E−20 | 5.5543E−20 | 0.0000 | 0.0000 |
| C₁ | −4.2500 | | | |

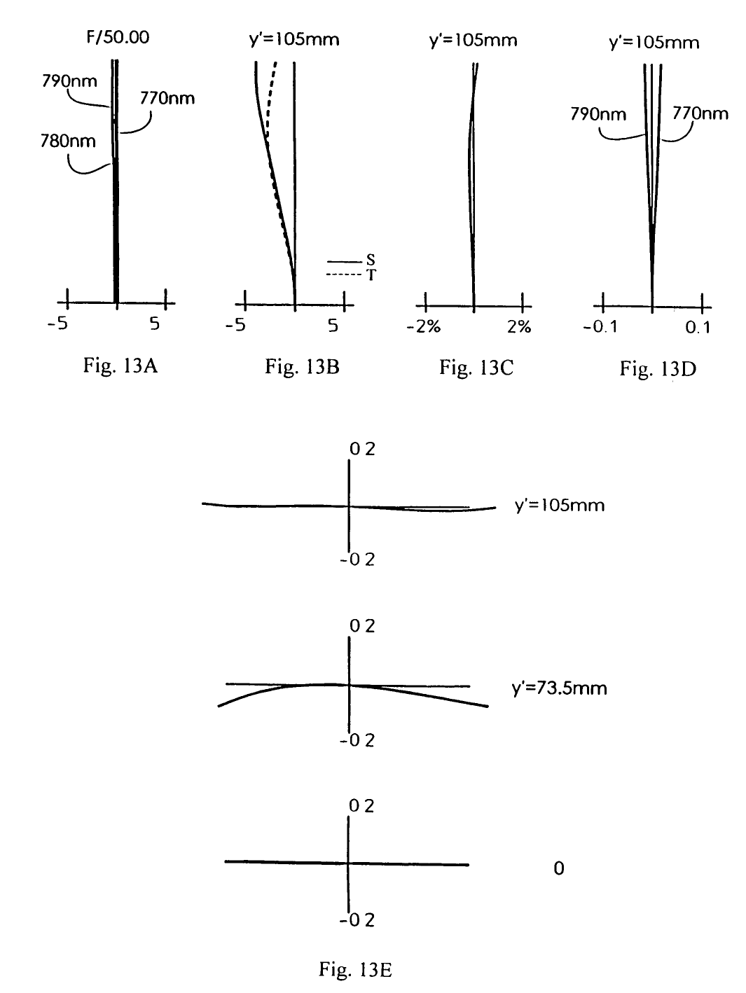

FIGS. 13A-13D show the spherical aberration, astigmatism, distortion, and lateral color, respectively, for this embodiment at a wavelength of 780 nm. The spherical aberration (in mm) and lateral color (in mm) are also shown for wavelengths 770 and 790 nm. The astigmatism (in mm) is shown for both the sagittal S and tangential T image surfaces. The f-number F_{NO} of this embodiment is listed in FIG. 13A and the maximum ray height y′=105 mm is listed in FIGS. 13B-13D. FIG. 13E shows the coma (in mm) for ray heights y′ of zero, 73.5 mm and 105 mm. As is evident from FIGS. 13A-13E, all these aberrations are favorably corrected for a wavelength of 780 nm.

### EMBODIMENT 8

The laser array imaging lens relating to the present embodiment is formed of two lens components, namely, a first lens component 21 having both the light-source-side surface and the surface nearest the scanned object be aspheric in shape, and a second lens component 22 having both the light-source-side surface and the surface nearest the scanned object be spherical in shape. At least one lens component is formed so as to have a so-called ‘compound aspheric surface’, wherein a thin plastic layer 6 (FIG. 6) is provided on a lens element that is made of glass. In the present invention, such a “compound aspheric surface” can be used instead of an aspheric lens surface made of glass. Further, due to the function of the first lens component 21, light beams situated in the vicinity of the center of each luminous flux from each laser element of the laser array light source intersect at a common region that is substantially a single point on the optical axis of the laser array imaging lens, and the stop 3 is arranged at this common region so that the laser array imaging lens is telecentric on the light-source side.

Table 8 below lists the surface number # (not counting the stop) of each optical surface in order from the light-source side, the radius of curvature R (in mm) near the optical axis of each optical surface, the on-axis spacing D (in mm) between surfaces, the index of refraction N₇₈₀ of the optical material of each lens element as measured at a wavelength of 780 nm, and the Abbe number ν_{d} (measured relative to the d-line) of the optical material of each lens element of Embodiment 8. Those surfaces in Table 8 having a * to the right of the surface number are aspheric. The middle portion of Table 8 lists the focal length f₁ of the first lens component, the focal length f₂ of the second lens component, the overall focal length f of the laser array imaging lens, the f-number F_{NO} of the laser array imaging lens of this embodiment, the distance L from the semiconductor laser array light source to the light-source-side surface of the first lens component, the overall thickness D′ of the laser array imaging lens, the distance L′ from the image-plane-side surface of the second lens component to a scanned surface at the image plane of the laser array imaging lens, the image magnification M, the total combined length TCL of the image-forming device as measured from the semiconductor laser array light source to the scanned surface, as well as the value of L/(D₂₁·(1−1/M)) corresponding to the above Condition (3). The lower portion of the table lists, for surfaces #1, #2 and #5, the value of the constant K as well as the values of the coefficients A₄, A₆, A₈ and A₁₀ of the aspheric lens surface used in Equation (A) above for the laser array imaging lens according to this embodiment. An “E” in the data indicates that the number following the “E” is the exponent to the base 10. For example, “1.0E-2” represents the number 1.0×10⁻².

TABLE 8

| # | R | D | N_{780 nm} | ν_{d} |
|---|---|---|---|---|
| 1* | 57.577 | 14.000 | 1.70400 | 53.9 |
| 2* | −180.840 | 57.178 (D₂₁) | | |
| | ∞ (stop) | 31.996 (D₂₂) | | |
| 3 | −20.535 | 8.000 | 1.70400 | 53.9 |
| 4 | −34.846 | 0.100 | 1.48471 | 57.5 |
| 5* | −36.254 | | | |

| | | | |
|---|---|---|---|
| f₁ = 63.577 | f₂ = −87.484 | f = 49.966 | F_{NO} = 50.000 |
| L = 103.756 | D′ = 111.274 | L′ = 390.070 | M = −8.467 |

| | |
|---|---|
| TCL = 605.100 | L/(D₂₁ · (1 − 1/M)) = 1.623 |

| | Aspheric Surface | Aspheric Surface | Aspheric Surface |
|---|---|---|---|
| | #1 | #2 | #5 |
| K | 8.6195E−1 | 4.1289 | 1.9996 |
| A₄ | −5.7466E−7 | 6.1657E−7 | −5.5188E−8 |
| A₆ | −3.6281E−12 | −6.9178E−12 | 8.4698E−13 |
| A₈ | 1.9195E−15 | 5.5554E−17 | 3.1668E−17 |
| A₁₀ | 9.8306E−20 | 4.5809E−21 | 5.6358E−22 |

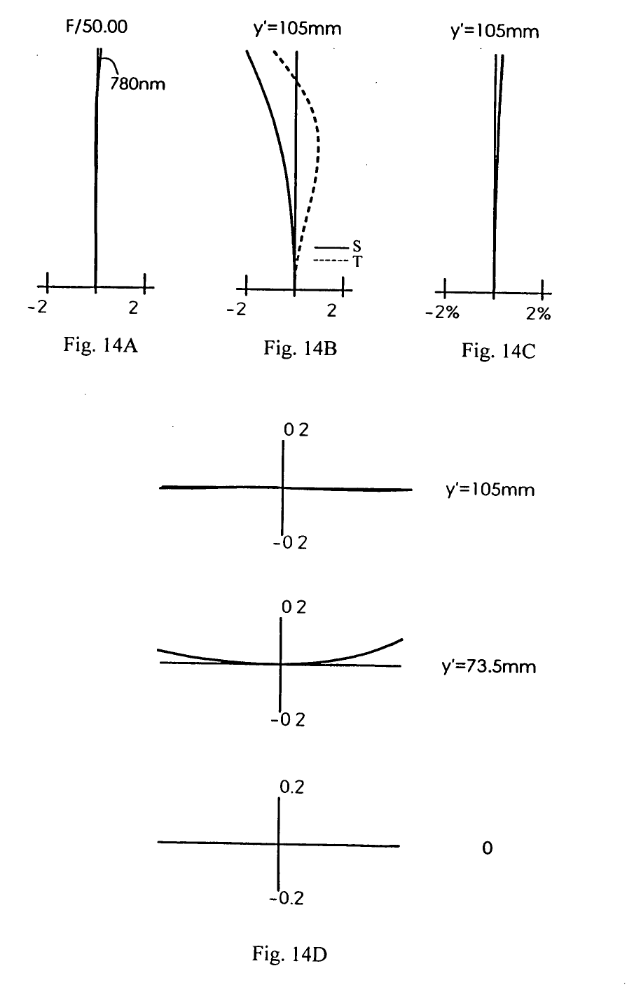

FIGS. 14A-14C show the spherical aberration, astigmatism, and distortion, respectively, for this embodiment at a wavelength of 780 nm. The spherical aberration (in mm), the astigmatism (in mm) for both the sagittal S and tangential T image surfaces, and the distortion are shown. The f-number F_{NO} of this embodiment is listed in FIG. 14A and the maximum ray height y′=105 mm is listed in FIGS. 14B-14C. FIG. 14D shows the coma (in mm) for ray heights y′ of zero, 73.5 mm and 105 mm. As is evident from FIGS. 14A-14D, all these aberrations are favorably corrected for a wavelength of 780 nm.

As is clear from FIGS. 7A through FIG. 14D, according to each of Embodiments 1 through 8, each aberration relative to the light beam with 780 nm of wavelength can all be corrected. Further, it is obvious that appropriately using an aspheric surface and/or an anamorphic, aspheric surface enables favorable correction of aberrations. Further, as is clear from the comparison of each aberration diagram for Embodiment 3 (FIGS. 9A-9E) and Embodiment 7 (FIGS. 13A-13E), according to Embodiment 7, due to the function of the diffraction optical element (DOE) surface, both the spherical aberration and the lateral color relative are greatly reduced at the wavelengths 770 nm and 790 nm. According to this construction, even a fluctuations in wavelength occur among different laser elements or within one laser element, excellent imaging quality can be maintained.

The invention being thus described, it will be obvious that the same may be varied in many ways. For example, the laser array imaging lens of the present invention is not limited to the embodiments disclosed in Embodiments 1 through 8. For example, the lens element configuration and/or the surface separations along the optical axis can be appropriately selected. Furthermore, the image-forming device for the present invention is not limited to a laser printer. For example, it can be an image-reading device wherein: an image is placed on a subject surface to be scanned; each laser element in the semiconductor laser array light source 1 sequentially or simultaneously flashes; the image is shifted along a direction, roughly perpendicular to the row direction of the dots formed by each focused luminous flux from the light source 1 on the surface to be scanned; and image information is obtained by establishing a means that receives the reflected light of the image. Further, in the device for the above-mentioned embodiments, a photosensitive surface is used as the subject surface to be scanned. However, as long as predetermined printing can be superimposed on the surface, a photosensitive surface is not required. Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

What is claimed is:

1. A laser array imaging lens comprising, in order from a light-source side, without any intervening lens component:
a first lens component; and
a second lens component, one lens surface of which is aspheric;
wherein
at least one lens surface of the laser array imaging lens is formed with an anamorphic, aspheric surface; and
at least one lens surface of the laser array imaging lens is formed having a diffractive optical element with a phase function either superimposed thereon or is provided as a separate surface.

2. The laser array imaging lens according to claim 1, wherein a stop is positioned on the image-plane side of the first lens component at a specified distance.

3. In combination:
a laser array light source; and
a laser array imaging lens which receives light from the laser array light source, the laser array imaging lens comprising, in order from the light-source side, without any intervening lens component:
a first lens component; and
a second lens component, one lens surface of which is aspheric;
wherein
at least one lens surface of the laser array imaging lens is formed with an anamorphic, aspheric surface; and
the following condition is satisfied
0.5<L/(D₂₁·(1−1/M))<2.0
where
L is the distance from the laser array light source to the light-source-side surface of the first lens component of the laser array imaging lens;
D₂₁ is the distance from the image-plane-side surface of the first lens component to the position where the central rays of the beams from the laser elements intersect the optical axis; and
M is the image magnification.

4. The combination according to claim 3, wherein a stop is positioned on the image-plane side of the first lens component at a specified distance.

5. An image-forming device that includes the laser array imaging lens according to claim 1, and further comprises:
a laser array light source made by arraying multiple light emitting elements in one or more rows;
means for independently modulating the individual light emitting elements of the laser array light source, based on a prescribed signal;
means for relatively moving a surface to be scanned, that is positioned substantially at an image surface of the laser array imaging lens, in a sub-scanning direction that is roughly perpendicular to the direction of the image dots that form one or more rows at the image surface.

6. An image-forming device that includes the laser array imaging lens according to claim 2, and further comprises:
a laser array light source made by arraying multiple light emitting elements in one or more rows;
means for independently modulating the individual light emitting elements of the laser array light source, based on a prescribed signal;
means for relatively moving a surface to be scanned and that is positioned substantially at the image surface of the laser array imaging lens, in a sub-scanning direction that is roughly perpendicular to the direction of the imaged dots that form one or more rows at the image surface.

7. An image-forming device that includes the combination according to claim 3, and further comprises:
means for independently modulating the individual light emitting elements of the laser array light source, based on a prescribed signal;
means for relatively moving a surface to be scanned and that is positioned substantially at the image surface of the laser array imaging lens, in a sub-scanning direction that is roughly perpendicular to the direction of imaged light spots that form one or more rows at the image surface.

8. An image-forming device that includes the combination according to claim 4, and further comprises:
means for independently modulating the individual light emitting elements of the laser array light source, based on a prescribed signal;
means for relatively moving a surface to be scanned and that is positioned substantially at the image surface of the laser array imaging lens, in a sub-scanning direction that is roughly perpendicular to the direction of the imaged dots that form one or more rows at the image surface.

9. The laser array imaging lens according to claim 1, wherein the first lens component consists of a single lens element.

10. The laser array imaging lens according to claim 2, wherein the first lens component consists of a single lens element.

11. The combination according to claim 3, wherein the first lens component consists of a single lens element.

12. The combination according to claim 4, wherein the first lens component consists of a single lens element.

13. The image-forming device according to claim 5, wherein the first lens component consists of a single lens element.

14. The image-forming device according to claim 6, wherein the first lens component consists of a single lens element.

15. The image-forming device according to claim 7, wherein the first lens component consists of a single lens element.

16. The image-forming device according to claim 8, wherein the first lens component consists of a single lens element.

17. The laser array imaging lens according to claim 2, wherein the stop is positioned so that the laser array imaging lens is substantially telecentric on the light-source side.

18. The combination according to claim 4, wherein the stop is positioned so that the laser array imaging lens is substantially telecentric on the light-source side.

19. The image-forming device according to claim 6, wherein the stop is positioned so that the laser array imaging lens is substantially telecentric on the light-source side.

20. The image-forming device according to claim 8, wherein the stop is positioned so that the laser array imaging lens is substantially telecentric on the light-source side.
